(19) United States
(12) Patent Application Publication
(10) Pub. No.: US 2017/0238771 A1
(43) Pub. Date: Aug. 24, 2017

(54) APPARATUS FOR WASHING AND DRYING HANDS

(71) Applicants: Nigel David WRIGHT, Sunbury (AU); Ken Tasman CHOATE, Crib Point (AU); Scott Garvan HURLEY, McLaren Vale (AU); Kerrie Dorothy WRIGHT, Sunbury (AU); Diana Joy CHOATE, Crib Point (AU); May Wan Khor, Melbourne (AU); David Frederick BURR, Melbourne (AU)

(72) Inventors: Nigel David WRIGHT, Melbourne (AU); Ken Tasman CHOATE, Melbourne (AU)

(21) Appl. No.: 15/280,905

(22) Filed: Sep. 29, 2016

Related U.S. Application Data
(63) Continuation of application No. 13/386,622, filed on Apr. 9, 2012, now abandoned.

(30) Foreign Application Priority Data
Jul. 23, 2009 (AU) 2009903456

(51) Int. Cl. A47K 10/48; B08B 3/02; B05B 1/04

(52) U.S. Cl. CPC A47K 10/48; B05B 1/04; B08B 3/02; A47K 2210/00

(57) ABSTRACT

Apparatus for washing and drying hands including a generally horizontal chamber having a defining wall, a central axis, an open end with an inwardly curved peripheral lip, a closed end, a top micro-spray nozzle arranged in the wall above the central axis, two side micro-spray nozzles arranged in the wall on opposed sides of the central axis, an air inlet arranged in the wall above the central axis, an air outlet arranged in the wall below the central axis, and two side air ducts exteriorly surrounding the wall to connect the air inlet to the air outlet, wherein in use liquid is sprayed from the top and side micro-spray nozzles to collectively establish a liquid curtain of micro-sprays across the central axis of the chamber, and air circulates within the chamber and recirculates around the chamber from the air outlet to the air inlet.

### CROSS-REFERENCE TO RELATED APPLICATIONS

This application is a continuation of U.S. patent application Ser. No. 13/386,622, filed Apr. 9, 2012, which is a 371 national phase application of PCT Application No. PCT/AU10/00832, filed Jun. 30, 2010, which claims the benefit of Australian Patent Application No. 2009903456, filed Jul. 23, 2009, all of which are incorporated by reference herein.

### FIELD OF THE INVENTION

The present invention relates to apparatus for washing and drying hands.

### BACKGROUND OF THE INVENTION

Apparatus for washing and drying hands generally include a chamber provided with sprays of water to wash the hands, and flows of drying air to dry them. Problems with existing apparatus include splashing of water, and blowing of air, outside the chamber. This leads to inefficient use of water and energy, as well as unhygienic contamination of surrounding areas.

What is needed are apparatus for washing and drying hands which provide for more efficient and hygienic use of water and drying air.

### SUMMARY OF THE INVENTION

According to the present invention, there is provided apparatus for washing and drying hands including a generally horizontal chamber having a defining wall, a central axis, an open end with an inwardly curved peripheral lip, a closed end, a top micro-spray nozzle arranged in the wall above the central axis, two side micro-spray nozzles arranged in the wall on opposed sides of the central axis, an air inlet arranged in the wall above the central axis, an air outlet arranged in the wall below the central axis, and two side air ducts exteriorly surrounding the wall to connect the air inlet to the air outlet, wherein in use liquid is sprayed from the top and side micro-spray nozzles to collectively establish a liquid curtain of micro-sprays across the central axis of the chamber, and air circulates within the chamber and recirculates around the chamber from the air outlet to the air inlet.

The chamber can have a circular, oval or elliptical vertical cross section.

The top and side micro-spray nozzles can each have a flat fan-shaped spray pattern. The top and side micro-spray nozzles can collectively establish a flat fan-shaped spray pattern within a sector having a sector angle of between 45 degrees and 180 degrees. The top and side micro-spray nozzles can be directed generally radially orthogonal to the central axis. For example, the top and side micro-spray nozzles can be directed radially inwards at an angle of 88 degrees to the central axis towards the closed end.

The air inlet can be partially fluidly connected to a diverter having two opposite facing air vents arranged in the chamber above the central axis, so that in use air is partially directed by the air vents toward the wall in opposite transverse directions relative to the central axis to thereby circulate air rotationally within the chamber about axes parallel to the central axis.

The inwardly curved peripheral lip of the open end can be disposed about the central axis within a sector having a sector angle of between 45 degrees and 180 degrees. The inwardly curved peripheral lip is formed as a continuation of the wall of the chamber that terminates in a rounded end. In use, the inwardly curved peripheral lip restricts air flowing axially out the open end of the chamber.

### BRIEF DESCRIPTION OF THE DRAWINGS

The invention will be further described by way of example only with reference to the accompanying drawings, in which:

FIG. 1 is a front cross sectional view of apparatus for washing and drying hands of one embodiment of the invention;

FIG. 2 is a side cross sectional view of the apparatus;

FIGS. 3(a) to 3(f) are respective front, side, front, plan, front and plan cross sectional views of the apparatus showing washing spray patterns of the apparatus;

FIG. 4 is a cross sectional plan view of the apparatus showing washing spray patterns of the apparatus;

FIGS. 5 and 6 are front cross sectional views of the apparatus showing drying air circulation of the apparatus; and

FIGS. 7 and 8 are side cross sectional views of the apparatus showing drying air circulation of the apparatus.

### DETAILED DESCRIPTION

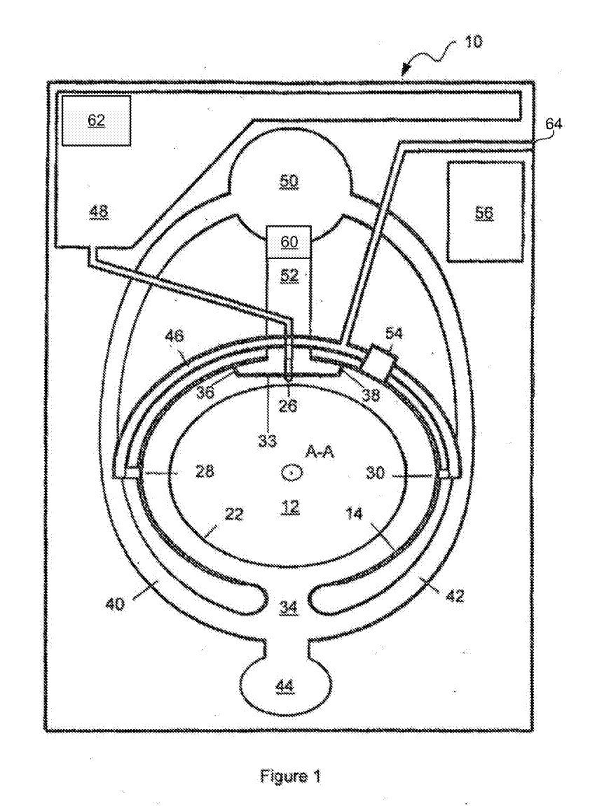

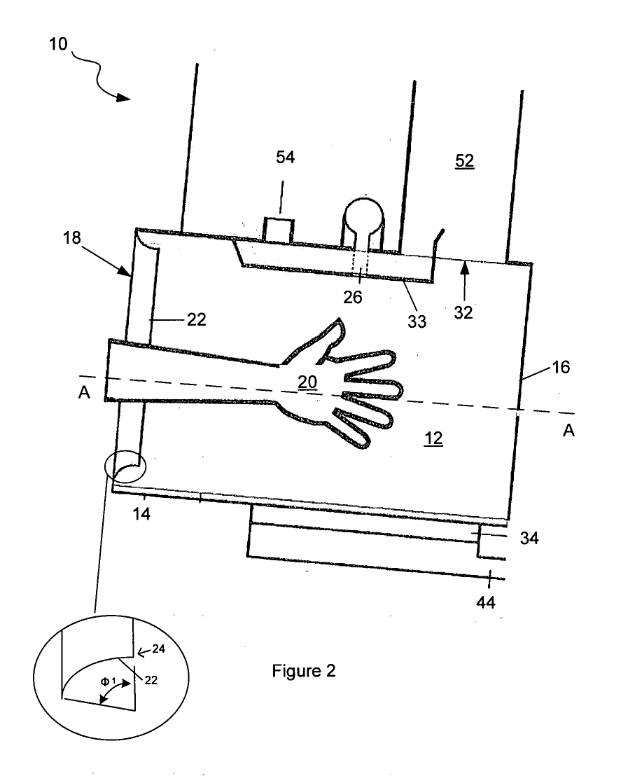

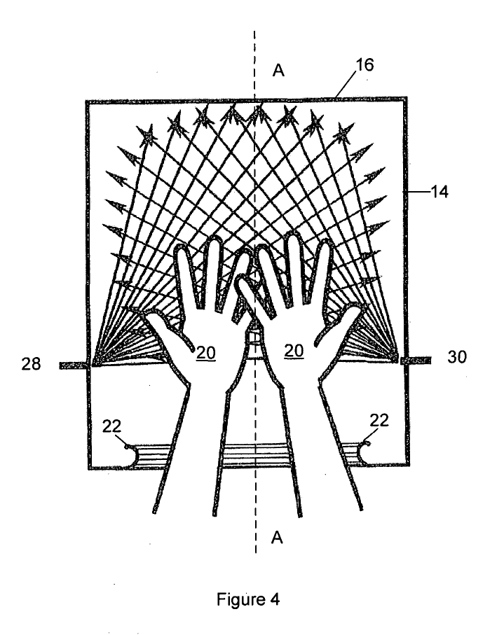

Referring to FIGS. 1 and 2, apparatus 10 for washing and drying hands of one embodiment of the invention includes a generally horizontal chamber 12 defined by a wall 14. The chamber 12 has an elliptical shape in vertical cross section with a longitudinal central axis A-A. The central axis A-A is, for example, slightly vertically inclined. The chamber 12 may have other equivalent shapes in vertical cross section, for example, oval or circular. The chamber 12 has a closed end 16 and an open end 18 sized and dimensioned to receive a pair of hands 20. The open end 18 has an inwardly curved peripheral lip 22 disposed about the central axis A-A within a sector having a sector angle φ₁ of, for example, between 45 degrees and 180 degrees. As illustrated in FIG. 4, the inwardly curved peripheral lip 22 can be formed as a continuation of the wall 14 of the chamber 12 that terminates in a rounded end 24 to minimise catching or cutting the hands 20. The chamber 12 is formed, for example, as an integral moulding in plastics.

A top micro-spray nozzle 26 is arranged in the wall 14 above the central axis A-A, and side micro-spray nozzles 28, 30 are arranged in the wall 14 on opposed sides of the central axis A-A. An air inlet 32 is arranged in the wall 14 above the central axis A-A, and an air outlet 34 is arranged in the wall 14 below the central axis A-A. The air inlet 32 is partially connected to a diverter 33 having two opposite facing air vents 36, 38 arranged in the chamber 12 above the central axis A-A. The air vents 36, 38 are oriented toward the wall 14 in opposite directions in a plane perpendicular to the central axis A-A. Two side air ducts 40, 42 exteriorly surround the wall 14 to connect the air inlet 32 to the air outlet 34. A drain 44 is provided below the air outlet 34.

Washing liquid, for example water and/or liquid soap, is supplied under pressure to the top and side micro-spray nozzles 26, 28, 30 via a manifold 46 which is fed from a reservoir 48. The washing liquid is dispensed in the form of micro-sprays, i.e. fine jets of relatively high pressure liquid. The washing liquid is pressurised by mains pressure or a pump (not shown), and is optionally heated by a water heater (not shown). Drying air is delivered from an air blower 50 to the air inlet 32 by a conduit 52. The drying air is optionally heated by an air heater (not shown). A controller 56, for example a programmable logic controller, selectively controls the ancillary components of the chamber 12 in response to a sensor 54, for example an optical sensor, sensing insertion of the hands 20 through the open end 18 of the chamber 12. The controller 56 is programmed to provide washing and drying cycles for the hands 20, and optionally a cleaning cycle for the chamber 12 between successive uses. A light (not shown) is also arranged in the wall 14 above the central axis A-A to illuminate the interior of the chamber 12. The chamber 12 and its ancillary components are provided in a common housing 58.

Soap, for example liquid soap, is added to the washing liquid by either pouring it in from an external container, or inserting a liquid soap package, for example a rupturable carton, into a soap chamber (not shown) in liquid communication with the washing liquid. The liquid soap package is configured to be received in the chamber (not shown) such that it is pierced upon insertion, allowing the liquid soap to fill the chamber. Alternatively, soap in a solid form, such as a bar, can be inserted directly in the chamber 12, and the washing liquid is configured to run through the chamber 12 to add dissolved solid soap to the washing liquid.

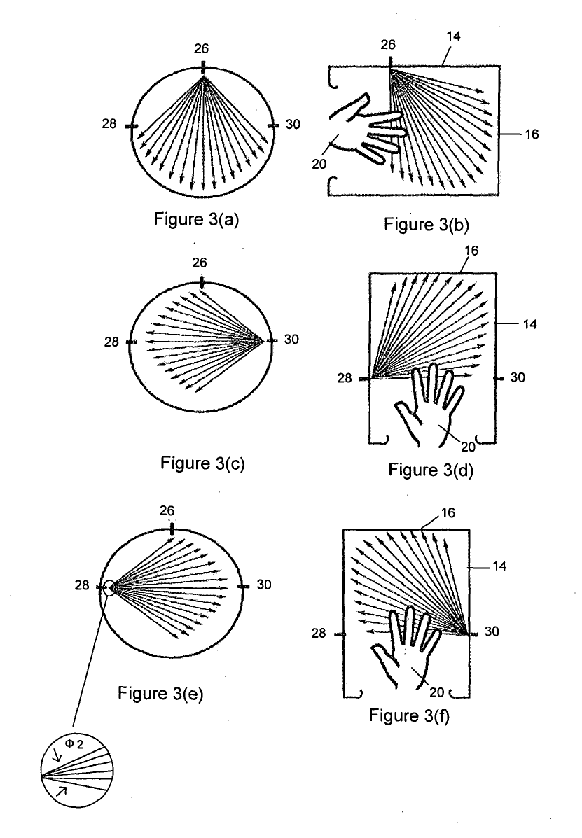

FIGS. 3(a) to 3(f) and 4 illustrate washing micro-spray patterns generated by the top and side micro-spray nozzles 26, 28, 30 during a washing cycle of the apparatus 10. As best seen in FIGS. 3(a) to 3(f), the top and side nozzles 26, 28, 30 each have a flat fan-shaped spray pattern. The top and side micro-spray nozzles 26, 28, 30 collectively establish a liquid curtain of micro-sprays having a collective flat fan-shaped spray pattern within a sector having a sector angle φ₂ of, for example, between 45 degrees and 180 degrees. The top and side micro-spray nozzles 26, 28, 30 are directed generally radially orthogonal to the central axis A-A. To minimise or prevent liquid spraying exteriorly of the open end 18 of the chamber 12, the top and side micro-spray nozzles 26, 28, 30 are directed radially inwards at an angle of 88 degrees to the central axis A-A towards the closed end 16.

In use, sensor 54 detects insertion of hands 20 inside the chamber 12. The controller 56 initiates the release of a quantity of soap, together with a supply of water, to the manifold 46. The resulting soap and water mixture is sprayed out top and side micro-spray nozzles 26, 28, 30 onto, around and over the hands 20. The orientation of the micro-spray nozzles 26, 28, 30 creates a vortex of air by drawing air into the chamber 12 minimise or prevent washing liquid spraying exteriorly of the open end 18 of the chamber 12. As best seen in FIG. 4, collectively, the top and side micro-spray nozzles 26, 28, 30 establish a liquid curtain of micro-sprays across the central axis A-A of the chamber 12.

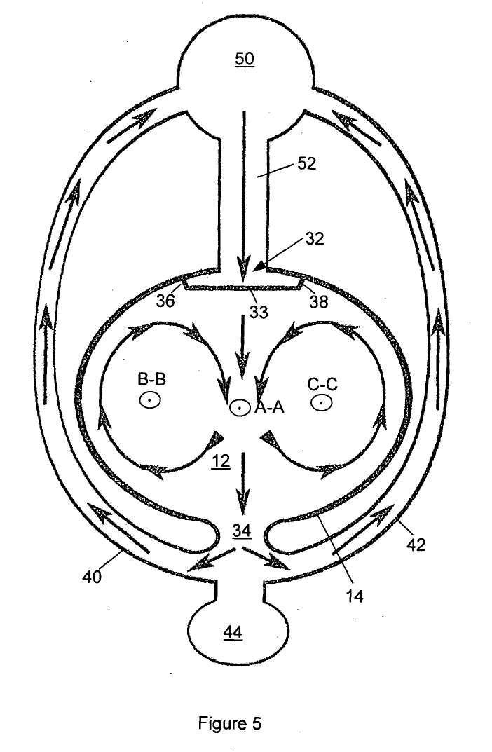

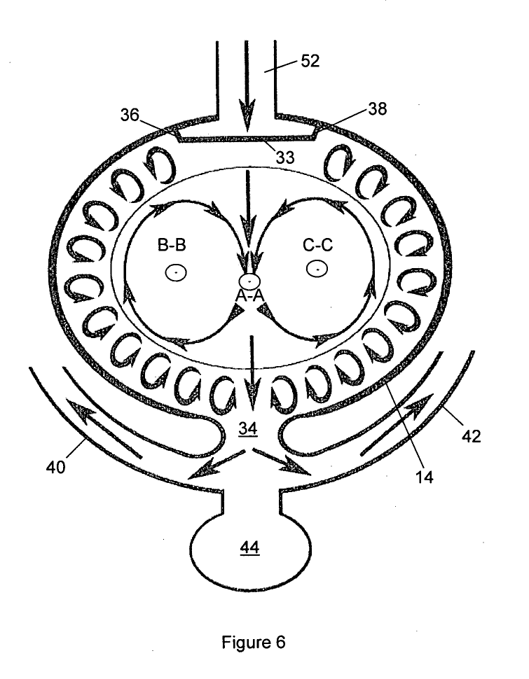

After a predetermined period, the controller 56 stops the supply of water and activates the 1.5 heater to supply drying air to the chamber 12. FIGS. 5 and 6 illustrate drying air circulation provided to the chamber 12 during a drying cycle of the apparatus 10. As best seen in FIG. 5, drying air is partially supplied to the chamber 12 by the air inlet 32 perpendicular to the central axis A-A. In addition, drying air is partially directed by the air vents 36, 38 of the diverter 33 toward the wall 14 in opposed transverse directions relative to the central axis A-A to thereby circulate the drying air rotationally within the chamber 12 about axes B-B and C-C which are generally parallel to the central axis A-A. Drying air is also recirculated exteriorly around the wall 14 of the chamber 12 from the air inlet 32 to the air outlet 34. While it is not intended to be bound to any particular theory, it is believed that the air currents about axes B-B and C-C are generated by the air pressure of the drying air being forced down the constrained conduit 52, from the fan 50, and then escaping the air inlet 32 into the relatively larger expanse of the curved wall chamber 12. This air then hits the curved sides of the chamber wall 14, forcing the air to rotate rapidly.

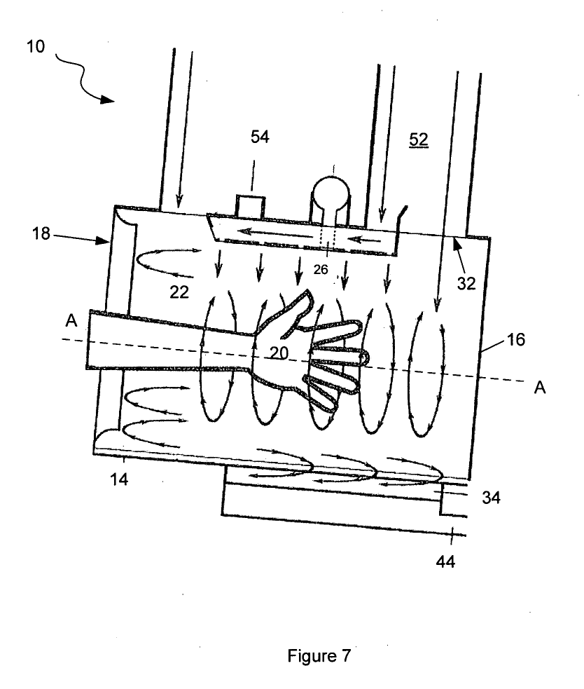

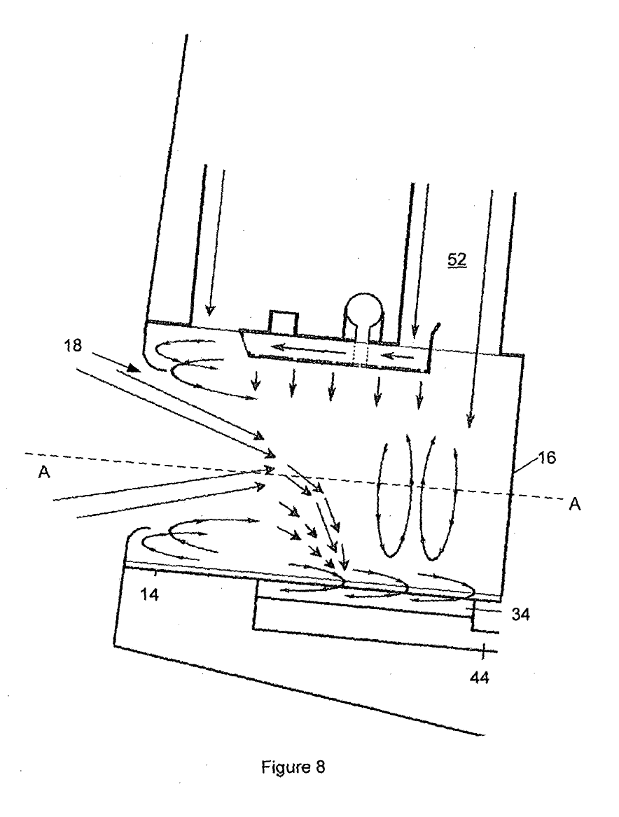

As can be seen in FIGS. 7 and 8, the inwardly curved peripheral lip 22 restricts air from escaping between the hands axially out the open end 18 of the chamber 12. As best seen in FIG. 6, the inwardly curved lip 22 also interacts with drying air circulating within the chamber 12 to generate smaller rotational air currents, or vortices, near the wall 14 of the chamber 12. As best seen in FIGS. 6 and 8, the vortices of drying inside the chamber 12 draw ambient air into the chamber 12 through the open end 18. The ambient air mixes with drying air circulating within the chamber 12, and the mixed air is directed to the air outlet 34 and then recirculated to the air inlet 32 by the side air ducts 40, 42.

It will be appreciated from the above description that embodiments of the invention provide for more efficient and hygienic use of washing liquid and drying air. This provides savings in operating costs in terms of water and energy.

The embodiments have been described by way of example only and modifications are possible within the scope of the claims which follow.

1. Apparatus for washing and drying hands including:
a generally horizontal chamber having a defined by a wall, the chamber having a central axis extending in a longitudinal direction, an open end with an inwardly curved peripheral lip, and a closed end;
a top micro-spray nozzle arranged in the wall above the central axis;
two side micro-spray nozzles arranged in the wall on opposed sides of the central axis;
an air inlet arranged in the wall above the central axis;
an air blower that includes a heater, the air blower being arranged to deliver drying air to the air inlet;
an air outlet arranged in the wall below the central axis;
a plurality of side air ducts that each surround at least a portion of the wall from the outside to connect the air outlet to the air blower, such that the air blower draws air from the chamber through the air outlet and then through the side air ducts; and
a diverter having two opposite facing air vents arranged in the chamber is disposed above the central axis, a part of the air from the air inlet is supplied to the diverter so that in use air is partially directed by the air vents toward the wall in opposite transverse directions relative to the central axis to thereby circulate air rotationally within the chamber about axes parallel to the central axis;
wherein in use washing liquid is sprayed from the top and side micro-spray nozzles to collectively establish a liquid curtain of micro-sprays across the central axis of the chamber, and air circulates within the chamber and recirculates around the chamber from the air outlet to the air inlet.

2. Apparatus according to claim 1, wherein the chamber has a circular, oval or elliptical vertical cross section.

3. Apparatus according to claim 1, wherein the top and side micro-spray nozzles each have a flat fan-shaped spray pattern.

4. Apparatus according to claim 3, wherein the top and side micro-spray nozzles collectively establish a flat fan-shaped spray pattern, each micro-spray nozzle being configured to spray the washing liquid within a circular sector having an internal angle of between 45 degrees and 180 degrees.

5. Apparatus according to claim 4, wherein the top and side micro-spray nozzles are directed generally radially orthogonal to the central axis.

6. Apparatus according to claim 5, wherein the top and side micro-spray nozzles are directed radially inwards at an angle of 88 degrees to the central axis towards the closed end.

7. Apparatus according to claim 1, wherein the inwardly curved peripheral lip can be formed as a continuation of the wall of the chamber that terminates in a rounded end.

8. Apparatus according to claim 1, wherein in use, the inwardly curved peripheral lip restricts air flowing axially out the open end of the chamber.

9. Apparatus according to claim 1, wherein the apparatus includes a chamber for storing a liquid to be added to the washing liquid.

10. Apparatus according to claim 9, wherein the liquid to be added to the washing liquid is a liquid soap.
